(19) United States
(12) Patent Application Publication
(10) Pub. No.: US 2017/0372567 A1
(43) Pub. Date: Dec. 28, 2017

(54) PET COMMUNICATION DEVICE

(71) Applicants: Samuel James Basi, Stamford, CT (US); Brandon Smith, Mahopac, NY (US)

(72) Inventors: Samuel James Basi, Stamford, CT (US); Brandon Smith, Mahopac, NY (US)

(21) Appl. No.: 15/630,351

(22) Filed: Jun. 22, 2017

Related U.S. Application Data
(60) Provisional application No. 62/353,308, filed on Jun. 22, 2016.

(51) Int. Cl. G08B 7/00; H04M 1/725; G06F 3/0488

(52) U.S. Cl. CPC G08B 7/00; H04M 1/72525; G06F 3/04883; H04M 2250/60

(57) ABSTRACT

A system and method for receiving a notification from a pet, such as a dog. The system includes a remote computer having a notification application loaded on a memory. The system further includes a pet unit having a press activator, a wireless transmitter and a processor. The processor transmits a signal to the remote computer via the wireless transmitter when the push activator is pushed by the pet. The signal activates the notification application to cause an alert to display on the remote computer.

### CROSS-REFERENCE TO RELATED APPLICATION

This application claims the benefit of priority of U.S. provisional application No. 62/353,308, filed Jun. 22, 2016, the contents of which are herein incorporated by reference.

### BACKGROUND OF THE INVENTION

The present invention relates to pets and, more particularly, to a pet communication device.

House-training is the process of training a dog to excrete (urinate and defecate) outdoors. Current methods of training dogs involve the dog notifying the owner that they need to go outside to excrete. For example, some dogs are trained to knock a bell by the door and others are trained to sit by the door. The owner may not notice a dog at the door or may not hear the dog ring the bell. In such cases, the dog may urinate or defecate inside the house.

As can be seen, there is a need for an improved system and method of determining when a pet needs to go outside.

### SUMMARY OF THE INVENTION

In one aspect of the present invention, a system for receiving a notification from a pet comprises: a remote computer comprising a notification application loaded on a memory; and a pet unit comprising a press activator, a wireless transmitter; and a processor, wherein the processor transmits a signal to the remote computer via the wireless transmitter when the push activator is pushed, and the signal activates the notification application to cause an alert to display on the remote computer.

In another aspect of the present invention, a method of communication between a pet and a user comprises the steps of: loading a notification application on a memory of a remote computer; placing a pet unit at ground level, wherein the pet unit comprises a press activator, a wireless transmitter; and a processor, wherein the processor transmits a signal to the remote computer via the wireless transmitter when the push activator is pushed, and the signal activates the notification application to cause an alert to display on the remote computer.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention; and

FIG. 2 is a flowchart of a method of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a pet unit with a press activator that sends push notifications to a mobile device when touched. The device may be used to alert dog owners that their pet needs to go outside/use bathroom, so indoor accidents can be avoided. The present invention may also allow owners to track pet schedules so they quickly notice changes or issues that can be indicative of health issues.

To use the present invention, a dog places a paw on the press activator which activates the pet unit to send a push notification to an application (on Android or IOS platform) alerting their owner they need to be let out. The application may capture and log every time the dog touches the press activator so schedules can be mapped. Since the pet unit is linked to the owner's mobile phone, there is a much higher likelihood of being alerted once the push notification has been sent. Further, the owner does not have to be at home and can still be alerted that their dog needs to go out. The tracking function is also an improvement as some health issues can be identified early by noticing changes in the dog's excrement habits.

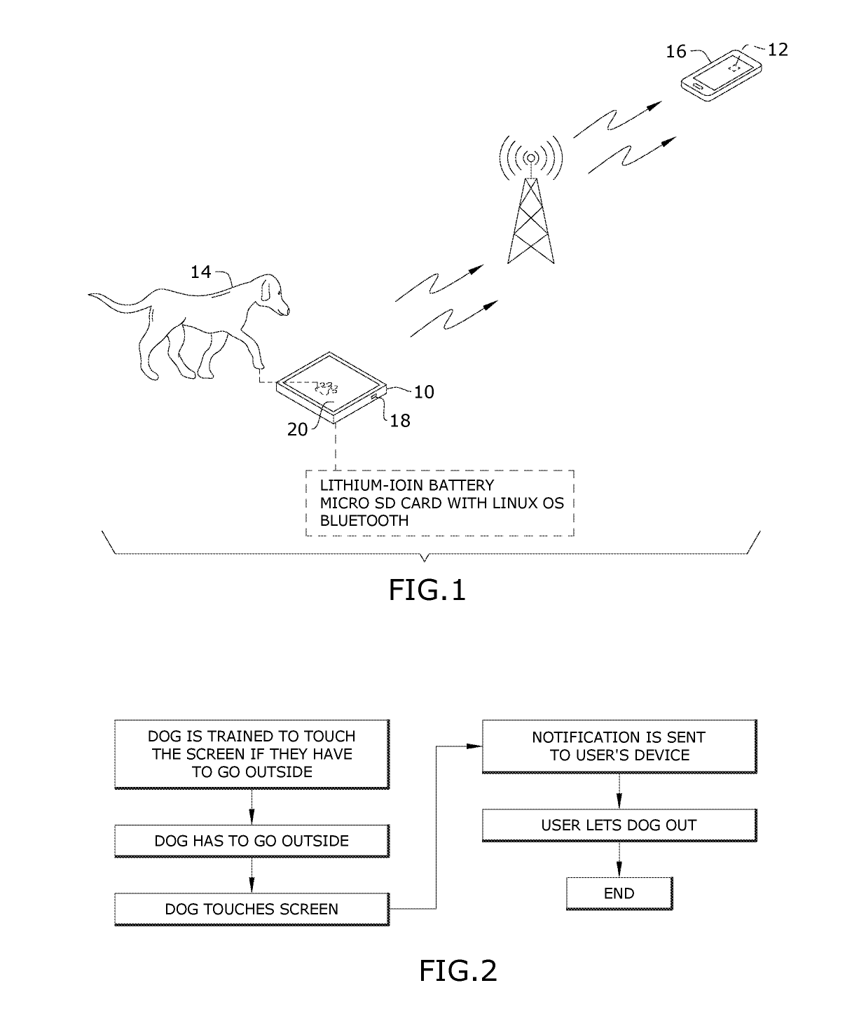

Referring to FIG. 1, the present invention includes a system for receiving a notification from a pet 14, such as a dog. The system includes a remote computer 16 having a notification application 12 loaded on a memory. The system further includes a pet unit 10 having a press activator 20, a wireless transmitter 18 and a processor. The processor transmits a signal to the remote computer 16 via the wireless transmitter 18 when the push activator 20 is pushed by the pet 14. The signal activates the notification application 12 to cause an alert to display on the remote computer 16.

The remote computer 12 of the present invention includes a processor and a memory. In certain embodiments, the remote computer 12 is a smart device, such as a smart phone or a tablet. The smart device may further include a touch screen, a speaker and a vibration device. When the signal activates the notification application 12, the alert may display on the touch screen, produce a noise on the speaker, activate the vibration device or a combination thereof.

The notification application 12 may be downloaded over the Internet and loaded on the memory of the remote computer 16. The notification application 12 may be automatically activated when the remote computer 16 receives the signal from the pet unit 10. In certain embodiments, the notification application 12 may create a log each time the remote computer 16 receives the signal. In such embodiments, each log may be saved on the memory of the remote computer 16. A user may navigate through the notification application 12 to bring up a record of the logs saved on the memory. Therefore, the user may check to see if there is any irregularity with the dog's routine.

As mentioned above, the pet unit 10 of the present invention may include a processor, a wireless transmitter 18 and a press activator 20. The press activator 20 may include a touchscreen, a physical button and the like. The pet unit 10 may further include a port to receive a micro SD card, a memory or a combination thereof. The micro SD card and/or memory may include an operating system so that a user may interact with and program the pet unit 10. The pet unit 10 may be powered by a battery or may include a power cord to plug into an electrical outlet. The pet unit 10 may further include a universal bus (USB) port to receive a USB drive. The pet unit 10 may also include a speaker. In such embodiments, a sound may be produced through the speaker when the pet touches the press activator 20.

The wireless transmitter 18 wirelessly transmits the signal to the remote computer. The wireless transmitter 18 may wirelessly transmit the signal via BLUETOOTH® Technology, a local area network, the Internet, a wireless communication server and the like.

A method of communication between a pet and a user may include the following. A notification application is loaded onto a memory of a remote computer, such as a smart phone. The pet unit mentioned above is placed at ground level so that the pet may press the press activator. The user trains their pet to press the pet unit with their paw when the pet needs to go outside. The processor of the pet unit transmits a signal to the remote computer via the wireless transmitter when the push activator is pushed by the dog. The signal activates the notification application to cause an alert to display on the remote computer. The user may then let the pet outside of the house.

It should be understood, of course, that the foregoing relates to exemplary embodiments of the invention and that modifications may be made without departing from the spirit and scope of the invention as set forth in the following claims.

What is claimed is:

1. A system for receiving a notification from a pet comprising:
a remote computer comprising a notification application loaded on a memory; and
a pet unit comprising a press activator, a wireless transmitter; and a processor, wherein
the processor transmits a signal to the remote computer via the wireless transmitter when the push activator is pushed, and
the signal activates the notification application to cause an alert to display on the remote computer.

2. The system of claim 1, wherein the press activator is a touch screen.

3. The system of claim 1, wherein the remote computer is a smart phone.

4. The system of claim 1, wherein the remote computer creates a log comprising a day and a time when the signal is received and stores the log on the memory.

5. A method of communication between a pet and a user comprising the steps of:
loading a notification application on a memory of a remote computer;
placing a pet unit at ground level, wherein the pet unit comprises a press activator, a wireless transmitter; and a processor, wherein
the processor transmits a signal to the remote computer via the wireless transmitter when the push activator is pushed, and
the signal activates the notification application to cause an alert to display on the remote computer.

6. The method of claim 5, wherein the press activator is a touch screen.

7. The method of claim 5, wherein the remote computer is a smart phone.

8. The method of claim 5, wherein the remote computer creates a log comprising a day and a time when the signal is received and stores the log on the memory.
